(19) United States
(12) Patent Application Publication
(10) Pub. No.: US 2008/0171672 A1
(43) Pub. Date: Jul. 17, 2008

(54) METHOD AND COMPOSITION FOR ENHANCED HYDROCARBONS RECOVERY

(76) Inventors: Manuel Luis CANO, Houston, TX (US); Kirk Herbert Raney, Houston, TX (US)

Correspondence Address: Shell Oil Company, 910 Louisiana, Houston, TX, 77002, US

(21) Appl. No.: 11/960,329

(22) Filed: Dec. 19, 2007

Related U.S. Application Data
(60) Provisional application No. 60/871,321, filed on Dec. 21, 2006.
(60) Provisional application No. 60/951,482, filed on Jul. 24, 2007.

(51) Int. Cl. C09K 8/60

(52) U.S. Cl. 507/227; 562/30

(57) ABSTRACT

A method of treating a hydrocarbon containing formation is described. The method includes providing a hydrocarbon recovery composition to the hydrocarbon containing formation. The hydrocarbon recovery composition includes a branched internal olefin sulfonate having an average carbon number of at least 15 and an average number of branches per molecule of at least about 0.8.

### CROSS REFERENCE TO RELATED APPLICATIONS

This application claims priority to U.S. provisional application Ser. No. 60/871,321, filed Dec. 21, 2006, and U.S. provisional application Ser. No. 60/951,482, filed Jul. 24, 2007, the entire disclosures of which are hereby incorporated by reference.

### FIELD OF THE INVENTION

The present invention generally relates to methods for recovery of hydrocarbons from hydrocarbon formations. More particularly, embodiments described herein relate to methods of enhanced hydrocarbons recovery and to compositions useful therein.

### BACKGROUND OF THE INVENTION

Hydrocarbons may be recovered from hydrocarbon containing formations by penetrating the formation with one or more wells. Hydrocarbons may flow to the surface through the wells. Conditions (e.g., permeability, hydrocarbon concentration, porosity, temperature, pressure) of the hydrocarbon containing formation may affect the economic viability of hydrocarbon production from the hydrocarbon containing formation. A hydrocarbon containing formation may have natural energy (e.g., gas, water) to aid in mobilizing hydrocarbons to the surface of the hydrocarbon containing formation. Natural energy may be in the form of water. Water may exert pressure to mobilize hydrocarbons to one or more production wells. Gas may be present in the hydrocarbon containing formation at sufficient pressures to mobilize hydrocarbons to one or more production wells. The natural energy source may become depleted over time. Supplemental recovery processes may be used to continue recovery of hydrocarbons from the hydrocarbon containing formation. Examples of supplemental processes include waterflooding, polymer flooding, alkali flooding, thermal processes, solution flooding or combinations thereof.

Compositions and methods for enhanced hydrocarbons recovery utilizing an alpha olefin sulfate-containing surfactant component are known. U.S. Pat. Nos. 4,488,976 and 4,537,253 describe enhanced oil or recovery compositions containing such a component. Compositions and methods for enhanced hydrocarbons recovery utilizing internal olefin sulfonates are also known. Such a surfactant composition is described in U.S. Pat. No. 4,597,879. The compositions described in the foregoing patents have the disadvantages that brine solubility and divalent ion tolerance are insufficient at certain reservoir conditions. U.S. Pat. No. 4,979,564 describes the use of internal olefin sulfonates in a method for enhanced oil recovery using low tension viscous water flood. An example of a commercially available material described as being useful was ENORDET IOS 1720, a product of Shell Oil Company identified as a sulfonated C₁₇₋₂₀ internal olefin sodium salt. This material has a low degree of branching.

### SUMMARY OF THE INVENTION

In an embodiment, hydrocarbons may be produced from a hydrocarbon containing formation by a method that includes treating at least a portion of the hydrocarbon containing formation with a hydrocarbon recovery composition. In certain embodiments, at least a portion of the hydrocarbon containing formation may be oil wet. In some embodiments, at least a portion of the hydrocarbon formation may include low salinity water. In other embodiments, at least a portion of the hydrocarbon containing formation may exhibit an average temperature of greater than about 30° C., even greater than about 60° C. Fluids, substances or combinations thereof may be added to at least a portion of the hydrocarbon containing formation to aid in mobilizing hydrocarbons to one or more production wells in certain embodiments.

In one embodiment, a hydrocarbon recovery composition may include a branched internal olefin sulfonate-containing surfactant. The branched internal olefin sulfonate may have an average carbon number of at least 15 or it may range from 15 to 26. As used herein, the phrase “carbon number” refers to the total number of carbons in a molecule. In certain embodiments, the average carbon number of the branched internal olefin sulfonate may range from 15 to 18 or from 17 to 20. In other embodiments, the average carbon number of the branched internal olefin sulfonate may range from 20 to 24. The average carbon number may be determined by NMR analysis. The average number of branches per molecule of the branched internal olefin sulfonate may be at least about 0.8 in some embodiments. Branches on the branched internal olefin sulfonate may include, but are not limited to, methyl and/or ethyl branches. In some embodiments, the average number of branches per molecule may be at least about 1 or at least about 2. The average number of branches per molecule is generally no more than about 3. The average number of branches per molecule may also be determined by NMR analysis.

In an embodiment, a hydrocarbon containing composition may be produced from a hydrocarbon containing formation. The hydrocarbon containing composition may include any combination of hydrocarbons, a branched internal olefin sulfonate, methane, water, asphaltenes, carbon monoxide and ammonia.

### BRIEF DESCRIPTION OF THE DRAWINGS

Advantages of the present invention will become apparent to those skilled in the art with the benefit of the following detailed description of embodiment and upon reference to the accompanying drawings, in which:

FIG. 1 depicts an embodiment of treating a hydrocarbon containing formation;

FIG. 2 depicts an embodiment of treating a hydrocarbon containing formation;

FIG. 3 depicts a graphical representation of interfacial tension values at 5% NaCl;

FIG. 4 depicts a graphical representation of interfacial tension values at 7% NaCl; and

FIG. 5 depicts a graphical representation of interfacial tension values at 9% NaCl.

While the invention is susceptible to various modifications and alternative forms, specific embodiments thereof are shown by way of example in the drawings and will herein be described in detail. It should be understood that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Hydrocarbons may be produced from hydrocarbon formations through wells penetrating a hydrocarbon containing formation. “Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen and/or sulfur. Hydrocarbons derived from a hydrocarbon formation may include, but are not limited to, kerogen, bitumen, pyrobitumen, asphaltenes, oils or combinations thereof. Hydrocarbons may be located within or adjacent to mineral matrices within the earth. Matrices may include, but are not limited to, sedimentary rock, sands, silicilytes, carbonates, diatomites and other porous media.

A “formation” includes one or more hydrocarbon containing layers, one or more non-hydrocarbon layers, an overburden and/or an underburden. An “overburden” and/or an “underburden” includes one or more different types of impermeable materials. For example, overburden/underburden may include rock, shale, mudstone, or wet/tight carbonate (i.e., an impermeable carbonate without hydrocarbons). For example, an underburden may contain shale or mudstone. In some cases, the overburden/underburden may be somewhat permeable. For example, an underburden may be composed of a permeable mineral such as sandstone or limestone. In some embodiments, at least a portion of a hydrocarbon containing formation may exist at less than or more than 1000 feet below the earth's surface.

Properties of a hydrocarbon containing formation may affect how hydrocarbons flow through an underburden/overburden to one or more production wells. Properties include, but are not limited to, porosity, permeability, pore size distribution, surface area, salinity or temperature of formation. Overburden/underburden properties in combination with hydrocarbon properties, such as, capillary pressure (static) characteristics and relative permeability (flow) characteristics may effect mobilization of hydrocarbons through the hydrocarbon containing formation.

Permeability of a hydrocarbon containing formation may vary depending on the formation composition. A relatively permeable formation may include heavy hydrocarbons entrained in, for example, sand or carbonate. “Relatively permeable,” as used herein, refers to formations or portions thereof, that have an average permeability of 10 millidarcy or more. “Relatively low permeability” as used herein, refers to formations or portions thereof that have an average permeability of less than about 10 millidarcy. One darcy is equal to about 0.99 square micrometers. An impermeable portion of a formation generally has a permeability of less than about 0.1 millidarcy. In some cases, a portion or all of a hydrocarbon portion of a relatively permeable formation may include predominantly heavy hydrocarbons and/or tar with no supporting mineral grain framework and only floating (or no) mineral matter (e.g., asphalt lakes).

Fluids (e.g., gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. In an embodiment, a first boundary may form between a water layer and underburden. A second boundary may form between a water layer and a hydrocarbon layer. A third boundary may form between hydrocarbons of different densities in a hydrocarbon containing formation. Multiple fluids with multiple boundaries may be present in a hydrocarbon containing formation, in some embodiments. It should be understood that many combinations of boundaries between fluids and between fluids and the overburden/underburden may be present in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult. Quantification of the interactions (e.g., energy level) at the interface of the fluids and/or fluids and overburden/underburden may be useful to predict mobilization of hydrocarbons through the hydrocarbon containing formation.

Quantification of energy required for interactions (e.g., mixing) between fluids within a formation at an interface may be difficult to measure. Quantification of energy levels at an interface between fluids may be determined by generally known techniques (e.g., spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (e.g., greater than about 10 dynes/cm) may indicate the inability of one fluid to mix with a second fluid to form a fluid emulsion. As used herein, an “emulsion” refers to a dispersion of one immiscible fluid into a second fluid by addition of a composition that reduces the interfacial tension between the fluids to achieve stability. The inability of the fluids to mix may be due to high surface interaction energy between the two fluids. Low interfacial tension values (e.g., less than about 1 dyne/cm) may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon containing formation.

Fluids in a hydrocarbon containing formation may wet (e.g., adhere to an overburden/underburden or spread onto an overburden/underburden in a hydrocarbon containing formation). As used herein, “wettability” refers to the preference of a fluid to spread on or adhere to a solid surface in a formation in the presence of other fluids. Methods to determine wettability of a hydrocarbon formation are described by Craig, Jr. in “The Reservoir Engineering Aspects of Waterflooding”, 1971 Monograph Volume 3, Society of Petroleum Engineers, which is herein incorporated by reference. In an embodiment, hydrocarbons may adhere to sandstone in the presence of gas or water. An overburden/underburden that is substantially coated by hydrocarbons may be referred to as “oil wet.” An overburden/underburden may be oil wet due to the presence of polar and/or heavy hydrocarbons (e.g., asphaltenes) in the hydrocarbon containing formation. Formation composition (e.g., silica, carbonate or clay) may determine the amount of adsorption of hydrocarbons on the surface of an overburden/underburden. In some embodiments, a porous and/or permeable formation may allow hydrocarbons to more easily wet the overburden/underburden. A substantially oil wet overburden/underburden may inhibit hydrocarbon production from the hydrocarbon containing formation. In certain embodiments, an oil wet portion of a hydrocarbon containing formation may be located at less than or more than 1000 feet below the earth's surface.

A hydrocarbon formation may include water. Water may interact with the surface of the underburden. As used herein, “water wet” refers to the formation of a coat of water on the surface of the overburden/underburden. A water wet overburden/underburden may enhance hydrocarbon production from the formation by preventing hydrocarbons from wetting the overburden/underburden. In certain embodiments, a water wet portion of a hydrocarbon containing formation may include minor amounts of polar and/or heavy hydrocarbons.

Water in a hydrocarbon containing formation may contain minerals (e.g., minerals containing barium, calcium, or magnesium) and mineral salts (e.g., sodium chloride, potassium chloride, magnesium chloride). Water salinity and/or water hardness of water in a formation may affect recovery of hydrocarbons in a hydrocarbon containing formation. As used herein “salinity” refers to an amount of dissolved solids in water. “Water hardness,” as used herein, refers to a concentration of divalent ions (e.g., calcium, magnesium) in the water. Water salinity and hardness may be determined by generally known methods (e.g., conductivity, titration). As used herein, “high salinity water” refers to water that has greater than about 30,000 ppm total dissolved solids based on sodium chloride. As water salinity increases in a hydrocarbon containing formation, interfacial tensions between hydrocarbons and water may be increased and the fluids may become more difficult to produce.

Low salinity water in a hydrocarbon containing formation may enhance hydrocarbon production from a hydrocarbon containing formation. Hydrocarbons and low salinity water may form a well dispersed emulsion due to a low interfacial tension between the low salinity water and the hydrocarbons. Production of a flowable emulsion (e.g., hydrocarbons/water mixture) from a hydrocarbon containing formation may be more economically viable to a producer. As used herein, “low salinity water” refers to water salinity in a hydrocarbon containing formation that is less than about 20,000 parts per million (ppm) total dissolved solids based on sodium chloride. In some embodiments, hydrocarbon containing formations may include water with a salinity of less than about 13,000 ppm. In certain embodiments, hydrocarbon containing formations may include water with a salinity ranging from about 3,000 ppm to about 10,000 ppm. In other embodiments, salinity of the water in hydrocarbon containing formations may range from about 5,000 ppm to about 8,000 ppm.

A hydrocarbon containing formation may be selected for treatment based on factors such as, but not limited to, thickness of hydrocarbon containing layers within the formation, assessed liquid production content, location of the formation, salinity content of the formation, temperature of the formation, and depth of hydrocarbon containing layers. Initially, natural formation pressure and temperature may be sufficient to cause hydrocarbons to flow into well bores and out to the surface. Temperatures in a hydrocarbon containing formation may range from about 0° C. to about 300° C. As hydrocarbons are produced from a hydrocarbon containing formation, pressures and/or temperatures within the formation may decline. Various forms of artificial lift (e.g., pumps, gas injection) and/or heating may be employed to continue to produce hydrocarbons from the hydrocarbon containing formation. Production of desired hydrocarbons from the hydrocarbon containing formation may become uneconomical as hydrocarbons are depleted from the formation.

Mobilization of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. In an embodiment, capillary forces may be overcome by increasing the pressures within a hydrocarbon containing formation. In other embodiments, capillary forces may be overcome by reducing the interfacial tension between fluids in a hydrocarbon containing formation. The ability to reduce the capillary forces in a hydrocarbon containing formation may depend on a number of factors, including, but not limited to, the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (e.g., brine, steam), gases, polymers, monomers or any combinations thereof to the hydrocarbon formation to increase mobilization of hydrocarbons.

In an embodiment, a hydrocarbon containing formation may be treated with a flood of water. A waterflood may include injecting water into a portion of a hydrocarbon containing formation through injections wells. Flooding of at least a portion of the formation may water wet a portion of the hydrocarbon containing formation. The water wet portion of the hydrocarbon containing formation may be pressurized by known methods and a water/hydrocarbon mixture may be collected using one or more production wells. The water layer, however, may not mix with the hydrocarbon layer efficiently. Poor mixing efficiency may be due to a high interfacial tension between the water and hydrocarbons.

Production from a hydrocarbon containing formation may be enhanced by treating the hydrocarbon containing formation with a polymer and/or monomer that may mobilize hydrocarbons to one or more production wells. The polymer and/or monomer may reduce the mobility of the water phase in pores of the hydrocarbon containing formation. The reduction of water mobility may allow the hydrocarbons to be more easily mobilized through the hydrocarbon containing formation. Polymers include, but are not limited to, polyacrylamides, partially hydrolyzed polyacrylamide, polyacrylates, ethylenic copolymers, biopolymers, carboxymethylcellulose, polyvinyl alcohol, polystyrene sulfonates, polyvinylpyrrolidone, AMPS (2-acrylamide-2-methyl propane sulfonate) or combinations thereof. Examples of ethylenic copolymers include copolymers of acrylic acid and acrylamide, acrylic acid and lauryl acrylate, lauryl acrylate and acrylamide. Examples of biopolymers include xanthan gum and guar gum. In some embodiments, polymers may be crosslinked in situ in a hydrocarbon containing formation. In other embodiments, polymers may be generated in situ in a hydrocarbon containing formation. Polymers and polymer preparations for use in oil recovery are described in U.S. Pat. No. 6,427,268 to Zhang et al., entitled “Method For Making Hydrophobically Associative Polymers, Methods of Use and Compositions;” U.S. Pat. No. 6,439,308 to Wang, entitled “Foam Drive Method;” U.S. Pat. No. 5,654,261 to Smith, entitled, “Permeability Modifying Composition For Use In Oil Recovery;” U.S. Pat. No. 5,284,206 to Surles et al., entitled “Formation Treating;” U.S. Pat. No. 5,199,490 to Surles et al., entitled “Formation Treating” and U.S. Pat. No. 5,103,909 to Morgenthaler et al., entitled “Profile Control In Enhanced Oil Recovery,” all of which are incorporated by reference herein.

In an embodiment, a hydrocarbon recovery composition may be provided to the hydrocarbon containing formation. In an embodiment, a composition may include a branched internal olefin sulfonate.

An internal olefin is an olefin whose double bond is located anywhere along the carbon chain except at a terminal carbon atom. A linear internal olefin does not have any alkyl, aryl, or alicyclic branching on any of the double bond carbon atoms or on any carbon atoms adjacent to the double bond carbon atoms. Typical commercial products produced by isomerization of alpha olefins are predominantly linear and contain a low average number of branches per molecule.

In one embodiment, the branched internal olefin may have an average carbon number of at least 15 or the average carbon number may range from 15 to 26. In certain embodiments, the average carbon number of the branched internal olefin may range from 15 to 18 or 17 to 20. In other embodiments, the average carbon number of the branched internal olefin may range from 20 to 24. The average carbon number may be determined by NMR analysis.

In another embodiment, the average number of branches per molecule of the branched internal olefin may be at least about 0.8. In another embodiment, the amount the branches per molecule in the branched internal olefin may be at least about 1, or at least about 2. The average number of branches per molecule is generally no more than about 3. The reason for this is that 3 is generally the most number of branches that can be incorporated with known technologies. The average number of branches per molecule may also be determined by NMR analysis. Without wishing to limit the scope of this invention in any way, we theorize that the role of the branching in the internal olefin within the ranges described above affects the internal molecular interaction in the molecule, affects the formation and type of micelles, prevents or discourages the formation of liquid crystals, reduces interfacial tension effectively, and allows emulsions to break up easier. This is advantageous because these properties allow efficient oil displacement and mobility within the pores of reservoir rock.

The internal olefins which are used to make the internal olefin sulfonates of the present invention may be made by skeletal isomerization. Suitable processes for making the branched internal olefins include those described in U.S. Pat. Nos. 5,510,306, 5,633,422, 5,648,584, 5,648,585, 5,849,960, and European Patent EP 0,830,315 B1, all of which are herein incorporated by reference in their entirety. A hydrocarbon stream comprising at least one linear olefin is contacted with a suitable catalyst, such as the catalytic zeolites described in the aforementioned patents, in a vapor phase at a suitable reaction temperature, pressure, and space velocity. Generally, suitable reaction conditions include a temperature of about 200 to about 650° C., an olefin partial pressure of above about 0.5 atmosphere, and a total pressure of about 0.5 to about 10.0 atmospheres or higher.

Preferably, the internal olefins of the present invention are made at a temperature in the range of from about 200 to about 500° C. at an olefin partial pressure of from about 0.5 to 2 atmospheres.

It is generally known that internal olefins are more difficult to sulfonate than alpha olefins (see “Tenside Detergents” 22 (1985) 4, pp. 193-195). In the article entitled “Why Internal Olefins are Difficult to Sulfonate,” the authors state that by the sulfonation of various commercial and laboratory produced internal olefins using falling film reactors, internal olefins gave conversions of below 90 percent and further they state that it was found necessary to raise the SO₃:internal olefin mole ratio to over 1.6:1 in order to achieve conversions above 95 percent. Furthermore, there resulting products were very dark in color and had high levels of di- and poly-sulfonated prducts.

U.S. Pat. Nos. 4,183,867 and 4,248,793, which are herein incorporated by reference, disclose processes which can be used to make the branched internal olefin sulfonates of the invention. They are carried out in a falling film reactor for the preparation of light color internal olefin sulfonates. The amounts of unreacted internal olefins are between 10 and 20 percent and at least 20 percent, respectively, in the processes and special measures must be taken to remove the unreacted internal olefins. The internal olefin suflonates containing between 10 and 20 percent and at least 20 percent, respectively, of unreacted internal olefins must be purified before being used. Consequently, the preparation of internal olefin sulfonates having the desired light color and with the desired low free oil content offer substantial difficulty.

Such difficulties can be avoided by following the process disclosed in European Patent EP 0,351,928 B1, which is herein incorporated by reference.

A process which can be used to make internal olefin sulfonates for use in the present invention comprises reacting in a film reactor an internal olefin as described above with a sulfonating agent in a mole ratio of sulfonating agent to internal olefin of 1:1 to 1.25:1 while cooling the reactor with a cooling means having a temperatures not exceeding 35° C., directly neutralizing the obtained reaction product of the sulfonating step and, without extracting the unreacted internal olefin, hydrolyzing the neutralized reaction product.

In the preparation of the sulfonates derived from internal olefins, the internal olefins are reacted with a sulfonating agent, which may be sulfur trioxide, sulfuric acid, or oleum, with the formation of beta-sultone and some alkane sulfonic acids. The film reactor is preferably a falling film reactor.

The reaction products are neutralized and hydrolyzed. Under certain circumstances, for instance, aging, the beta-sultones are converted into gamma-sultones which may be converted into delta-sultones. After neutralization and hydrolysis, gamma-hydroxy sulfonates and delta-hydroxy sulfonates are obtained. A disadvantage of these two sultones is that they are more difficult to hydrolyze than beta-sultones. Thus, in most embodiments it is preferable to proceed without aging. The beta sultones, after hydrolysis, give beta-hydroxy sulfonates. These materials do not have to be removed because they form useful surfactant structures.

The cooling means, which is preferably water, has a temperature not exceeding 35° C., especially a temperature in the range of from 0 to 25° C. Depending upon the circumstances, lower temperatures may be used as well.

The reaction mixture is then fed to a neutralization hydrolysis unit. The neutralization/hydrolysis is carried out with a water soluble base, such as sodium hydroxide or sodium carbonate. The corresponding bases derived from potassium or ammonium are also suitable. The neutralization of the reaction product from the falling film reactor is generally carried out with excessive base, calculated on the acid component. Generally, neutralization is carried out at a temperature in the range of from 0 to 80° C. Hydrolysis may be carried out at a temperature in the range of from 100 to 250° C., preferably 130 to 200° C. The hydrolysis time generally may be from 5 minutes to 4 hours. Alkaline hydrolysis may be carried out with hydroxides, carbonates, bicarbonates of (earth) alkali metals, and amine compounds.

This process may be carried out batchwise, semi-continuously, or continuously. The reaction is generally performed in a falling film reactor which is cooled by flowing a cooling means at the outside walls of the reactor. At the inner walls of the reactor, the internal olefin flows in a downward direction. Sulfur trioxide is diluted with a stream of nitrogen, air, or any other inert gas into the reactor. The concentration of sulfur trioxide generally is between 2 and 4 percent by volume based on the volume of the carrier gas. In the preparation of internal olefin sulfonates derived from the olefins of the present invention, it is required that in the neutralization hydrolysis step very intimate mixing of the reactor product and the aqueous base is achieved. This can be done, for example, by efficient stirring or the addition of a polar cosolvent (such as a lower alcohol) or by the addition of a phase transfer agent.

In one embodiment, the hydrocarbon recovery composition may include a branched internal olefin sulfonate surfactant as described above. In some embodiments, an amount of a branched internal olefin sulfonate surfactant in a composition may be greater than about 10 wt. % of the total composition. In an embodiment, an amount of a branched internal olefin sulfonate surfactant in a hydrocarbon recovery composition main range from about 10 wt. % to about 80 wt. % of the total composition. An amount of a branched internal olefin sulfonate surfactant in a composition may range from about 30 wt. % to about 60 wt. % of the total weight of the composition. The remainder of the composition may include, but is not limited to, water, low molecular weight alcohols, organic solvents, alkyl sulfonates, aryl sulfonates, brine or combinations thereof. Low molecular weight alcohols include, but are not limited to, methanol, ethanol, propanol, isopropyl alcohol, tert-butyl alcohol, sec-butyl alcohol, butyl alcohol, tert-amyl alcohol or combinations thereof. Organic solvents include, but are not limited to, methyl ethyl ketone, acetone, lower alkyl cellosolves, lower alkyl carbitols or combinations thereof.

The hydrocarbon recovery composition may interact with hydrocarbons in at least a portion of the hydrocarbon containing formation. Interaction with the hydrocarbons may reduce an interfacial tension of the hydrocarbons with one or more fluids in the hydrocarbon containing formation. In other embodiments, a hydrocarbon recovery composition may reduce the interfacial tension between the hydrocarbons and an overburden/underburden of a hydrocarbon containing formation. Reduction of the interfacial tension may allow at least a portion of the hydrocarbons to mobilize through the hydrocarbon containing formation.

The ability of a hydrocarbon recovery composition to reduce the interfacial tension of a mixture of hydrocarbons and fluids may be evaluated using known techniques. In an embodiment, an interfacial tension value for a mixture of hydrocarbons and water may be determined using a spinning drop tensiometer. An amount of the hydrocarbon recovery composition may be added to the hydrocarbon/water mixture and an interfacial tension value for the resulting fluid may be determined. A low interfacial tension value (e.g., less than about 1 dyne/cm) may indicate that the composition reduced at least a portion of the surface energy between the hydrocarbons and water. Reduction of surface energy may indicate that at least a portion of the hydrocarbon/water mixture may mobilize through at least a portion of a hydrocarbon containing formation.

In an embodiment, a hydrocarbon recovery composition may be added to a hydrocarbon/water mixture and the interfacial tension value may be determined. An ultralow interfacial tension value (e.g., less than about 0.01 dyne/cm) may indicate that the hydrocarbon recovery composition lowered at least a portion of the surface tension between the hydrocarbons and water such that at least a portion of the hydrocarbons may mobilize through at least a portion of the hydrocarbon containing formation. At least a portion of the hydrocarbons may mobilize more easily through at least a portion of the hydrocarbon containing formation at an ultra low interfacial tension than hydrocarbons that have been treated with a composition that results in an interfacial tension value greater than 0.01 dynes/cm for the fluids in the formation. Addition of a hydrocarbon recovery composition to fluids in a hydrocarbon containing formation that results in an ultra-low interfacial tension value may increase the efficiency at which hydrocarbons may be produced. A hydrocarbon recovery composition concentration in the hydrocarbon containing formation may be minimized to minimize cost of use during production.

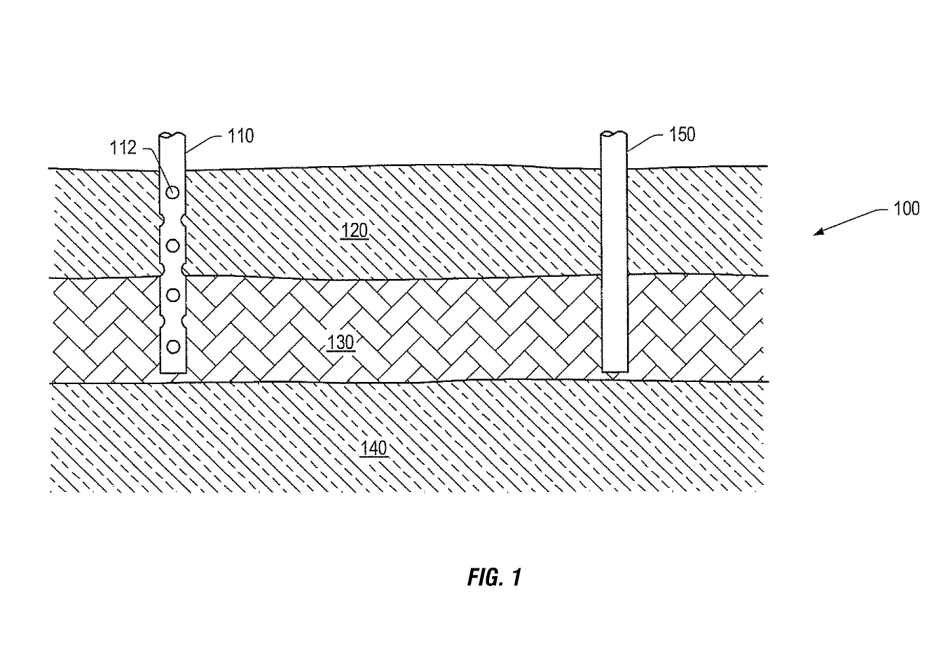

In an embodiment of a method to treat a hydrocarbon containing formation, a hydrocarbon recovery composition including a branched olefin sulfonate may be provided (e.g., injected) into hydrocarbon containing formation 100 through injection well 110 as depicted in FIG. 1. Hydrocarbon formation 100 may include overburden 120, hydrocarbon layer 130, and underburden 140. Injection well 110 may include openings 112 that allow fluids to flow through hydrocarbon containing formation 100 at various depth levels. In certain embodiments, hydrocarbon layer 130 may be less than 1000 feet below earth's surface. In some embodiments, underburden 140 of hydrocarbon containing formation 100 may be oil wet. Low salinity water may be present in hydrocarbon containing formation 100, in other embodiments.

A hydrocarbon recovery composition may be provided to the formation in an amount based on hydrocarbons present in a hydrocarbon containing formation. The amount of hydrocarbon recovery composition, however, may be too small to be accurately delivered to the hydrocarbon containing formation using known delivery techniques (e.g., pumps). To facilitate delivery of small amounts of the hydrocarbon recovery composition to the hydrocarbon containing formation, the hydrocarbon recovery composition may be combined with water and/or brine to produce an injectable fluid. An amount of a hydrocarbon recovery composition injected into hydrocarbon containing formation 100 may be less than 0.5 wt. % of the total weight of the injectable fluid. In certain embodiments, an amount of a hydrocarbon recovery composition provided to a hydrocarbon containing formation may be less than 0.3 wt. % of the total weight of injectable fluid. In some embodiments, an amount of a hydrocarbon recovery composition provided to a hydrocarbon containing formation may be less than 0.1 wt. % of the total weight of injectable fluid. In other embodiments, an amount of a hydrocarbon recovery composition provided to a hydrocarbon containing formation may be less than 0.05 wt. % of the total weight of injectable fluid.

The hydrocarbon recovery composition may interact with at least a portion of the hydrocarbons in hydrocarbon layer 130. The interaction of the hydrocarbon recovery composition with hydrocarbon layer 130 may reduce at least a portion of the interfacial tension between different hydrocarbons. The hydrocarbon recovery composition may also reduce at least a portion of the interfacial tension between one or more fluids (e.g., water, hydrocarbons) in the formation and the underburden 140, one or more fluids in the formation and the overburden 120 or combinations thereof. In an embodiment, a hydrocarbon recovery composition may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. An interfacial tension value between the hydrocarbons and one or more fluids may be altered by the hydrocarbon recovery composition to a value of less than about 0.1 dyne/cm. In some embodiments, an interfacial tension value between the hydrocarbons and other fluids in a formation may be reduced by the hydrocarbon recovery composition to be less than about 0.05 dyne/cm. An interfacial tension value between hydrocarbons and other fluids in a formation may be lowered by the hydrocarbon recovery composition to less than 0.001 dyne/cm, in other embodiments. At least a portion of the hydrocarbon recovery composition/hydrocarbon/fluids mixture may be mobilized to production well 150. Products obtained from the production well 150 may include, but are not limited to, components of the hydrocarbon recovery composition (e.g., a long chain aliphatic alcohol and/or a long chain aliphatic acid salt), methane, carbon monoxide, water, hydrocarbons, ammonia, asphaltenes, or combinations thereof. Hydrocarbon production from hydrocarbon containing formation 100 may be increased by greater than about 50% after the hydrocarbon recovery composition has been added to a hydrocarbon containing formation.

In certain embodiments, hydrocarbon containing formation 100 may be pretreated with a hydrocarbon removal fluid. A hydrocarbon removal fluid may be composed of water, steam, brine, gas, liquid polymers, foam polymers, monomers or mixtures thereof. A hydrocarbon removal fluid may be used to treat a formation before a hydrocarbon recovery composition is provided to the formation. Hydrocarbon containing formation 100 may be less than 1000 feet below the earth's surface, in some embodiments. A hydrocarbon removal fluid may be heated before injection into a hydrocarbon containing formation 100, in certain embodiments. A hydrocarbon removal fluid may reduce a viscosity of at least a portion of the hydrocarbons within the formation. Reduction of the viscosity of at least a portion of the hydrocarbons in the formation may enhance mobilization of at least a portion of the hydrocarbons to production well 150. After at least a portion of the hydrocarbons in hydrocarbon containing formation 100 have been mobilized, repeated injection of the same or different hydrocarbon removal fluids may become less effective in mobilizing hydrocarbons through the hydrocarbon containing formation. Low efficiency of mobilization may be due to hydrocarbon removal fluids creating more permeable zones in hydrocarbon containing formation 100. Hydrocarbon removal fluids may pass through the permeable zones in the hydrocarbon containing formation 100 and not interact with and mobilize the remaining hydrocarbons. Consequently, displacement of heavier hydrocarbons adsorbed to underburden 140 may be reduced over time. Eventually, the formation may be considered low producing or economically undesirable to produce hydrocarbons.

In certain embodiments, injection of a hydrocarbon recovery composition after treating the hydrocarbon containing formation with a hydrocarbon removal fluid may enhance mobilization of heavier hydrocarbons absorbed to underburden 140. The hydrocarbon recovery composition may interact with the hydrocarbons to reduce an interfacial tension between the hydrocarbons and underburden 140. Reduction of the interfacial tension may be such that hydrocarbons are mobilized to and produced from production well 150. Produced hydrocarbons from production well 150 may include, in some embodiments, at least a portion of the components of the hydrocarbon recovery composition, the hydrocarbon removal fluid injected into the well for pretreatment, methane, carbon dioxide, ammonia, or combinations thereof. Adding the hydrocarbon recovery composition to at least a portion of a low producing hydrocarbon containing formation may extend the production life of the hydrocarbon containing formation. Hydrocarbon production from hydrocarbon containing formation 100 may be increased by greater than about 50% after the hydrocarbon recovery composition has been added to hydrocarbon containing formation. Increased hydrocarbon production may increase the economic viability of the hydrocarbon containing formation.

The internal olefin sulfonate component of the composition is thermally stable and may be used over a wide range of temperature. To facilitate delivery of an amount of the hydrocarbon recovery composition to the hydrocarbon containing formation, the hydrocarbon composition may be combined with water or brine to produce an injectable fluid. Less than about 0.5 wt % of the hydrocarbon recovery composition, based on the total weight of injectable fluid, may be injected into hydrocarbon containing formation 100 through injection well 110. In certain embodiments, the concentration of the hydrocarbon recovery composition injected through injection well 110 may be less than 0.3 wt. %, based on the total weight of injectable fluid. In some embodiments, the concentration of the hydrocarbon recovery composition may be less 0.1 wt. % based on the total weight of injectable fluid. In other embodiments, the concentration of the hydrocarbon recovery composition may be less 0.05 wt. % based on the total weight of injectable fluid.

Interaction of the hydrocarbon recovery composition with at least a portion of hydrocarbons in the formation may reduce at least a portion of an interfacial tension between the hydrocarbons and underburden 140. Reduction of at least a portion of the interfacial tension may mobilize at least a portion of hydrocarbons through hydrocarbon containing formation 100. Mobilization of at least a portion of hydrocarbons, however, may not be at an economically viable rate. In one embodiment, polymers may be injected into hydrocarbon formation 100 through injection well 110, after treatment of the formation with a hydrocarbon recovery composition, to increase mobilization of at least a portion of the hydrocarbons through the formation. Suitable polymers include, but are not limited to, CIBA® ALCOFLOOD®, manufactured by Ciba Specialty Additives (Tarrytown, N.Y.), Tramfloc® manufactured by Tramfloc Inc. (Temple, Ariz.), and HE® polymers manufactured by Chevron Phillips Chemical Co. (The Woodlands, Tex.). Interaction between the hydrocarbons, the hydrocarbon recovery composition and the polymer may increase mobilization of at least a portion of the hydrocarbons remaining in the formation to production well 150.

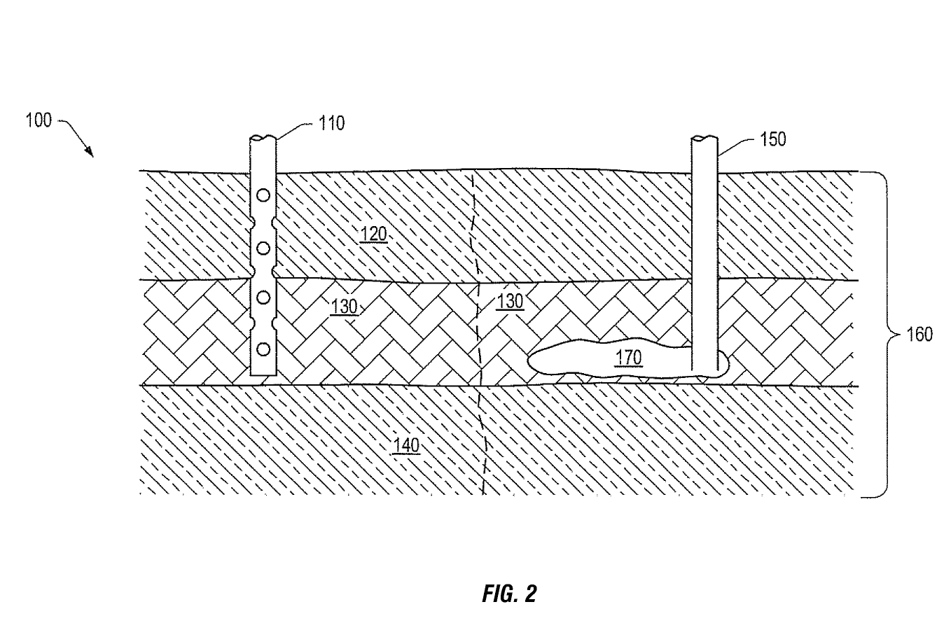

In some embodiments, a hydrocarbon recovery composition may be added to a portion of a hydrocarbon containing formation 100 that has an average temperature of from 0 to 150° C. because of the high thermal stability of the internal olefin sulfonate. In some embodiments, a hydrocarbon recovery composition may be combined with at least a portion of a hydrocarbon removal fluid (e.g. water, polymer solutions) to produce an injectable fluid. Less than about 0.5 wt % of the hydrocarbon recovery composition, based on the total weight of injectable fluid, may be injected into hydrocarbon containing formation 100 through injection well 110 as depicted in FIG. 2. In certain embodiments, a concentration of the hydrocarbon recovery composition injected through injection well 110 may be less than 0.3 wt. %, based on the total weight of injectable fluid. In some embodiments, less than 0.1 wt. % of the hydrocarbon recovery composition, based on the total weight of injectable fluid, may be injected through injection well 110 into hydrocarbon containing formation 100. In other embodiments, less than 0.05 wt. % of the hydrocarbon recovery composition, based on the total weight of injectable fluid, may be injected through injection well 110 into hydrocarbon containing formation 100. Interaction of the hydrocarbon recovery composition with hydrocarbons in the formation may reduce at least a portion of an interfacial tension between the hydrocarbons and underburden 140. Reduction of at least a portion of the interfacial tension may mobilize at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

In other embodiments, mobilization of at least a portion of hydrocarbons to selected section 160 may not be at an economically viable rate. Polymers may be injected into hydrocarbon formation 100 to increase mobilization of at least a portion of the hydrocarbons through the formation. Interaction between at least a portion of the hydrocarbons, the hydrocarbon recovery composition and the polymers may increase mobilization of at least a portion of the hydrocarbons to production well 150.

In some embodiments, a hydrocarbon recovery composition may include an inorganic salt (e.g. sodium carbonate (Na₂CO₃), sodium chloride (NaCl), or calcium chloride (CaCl₂)). The addition of the inorganic salt may help the hydrocarbon recovery composition disperse throughout a hydrocarbon/water mixture. The enhanced dispersion of the hydrocarbon recovery composition may decrease the interactions between the hydrocarbon and water interface. The decreased interaction may lower the interfacial tension of the mixture and provide a fluid that is more mobile.

In another embodiment, a hydrocarbon recovery composition may include polymers and/or monomers. As described above, polymers may be used to increase mobilization of at least a portion of the hydrocarbons through the formation. Suitable polymers have been described previously. Interaction between the hydrocarbons and the polymer containing hydrocarbon recovery composition may increase mobilization of at least a portion of the hydrocarbons remaining in the formation.

### EXAMPLES

### Example 1

Hydrocarbon recovery compositions including branched internal olefin sulfonates were prepared and interfacial tension measurements were compared for a variety of different compositions. Three different branched C₁₅₋₁₈ internal olefins were made (25731-77-2 with a medium amount of branching, 25731-78-2 with a higher amount of branching and 25889-113 which was intended to be representative of mostly linear internal olefins used previously for hydrocarbon recovery). These internal olefins were characterized by NMR analysis. The average number of branches per molecule analyses are shown in Table 1. The NMR analysis was carried out as described below.

This method describes the characterization of branched olefins. The proton nuclear magnetic resonance (1H NMR) method assays the various types of olefinic units and reports the average number of branches per molecule, and the number of aliphatic and olefinic branches per chain.

Typically, 0.1 ml of sample is dissolved in 1.0 ml of deuterated chloroform and transferred to a high-grade 5 mm NMR tube. The H1-NMR data is acquired, processed and branching and olefin analyses are computed as detailed below. The method assumes that the sample contains only acyclic, hydrocarbon, mono-olefins. The method is not intended to be used in the presence of dienes, naphthenes, paraffins, aromatics, or heteroatom-containing species. It is assumed that the olefins are of sufficient molecular weight and low volatility that the sample may be easily handled at room temperature without loss of material. It is assumed that the olefins are not so large that they will not readily dissolve in chloroform. Long, linear, wax-like molecules might not be readily soluble in chloroform at room temperature. Another solvent may be necessary. The chloroform solvent used for dissolution of the sample should be dry since water in the solvent will interfere with the analysis.

### Apparatus

Varian Inova 500 spectrometer (or equivalent) equipped with a 5 mm ¹H-only or ¹³C/¹H dual probe.
Denville Scientific Pipete-Mate Pipettors (1000 ul and 100 ul). Denville Scientific Company.
5-mm high grade NMR sample tubes with plastic caps. Kontes Glass Company.

### Operating Conditions

The following acquisition parameters are used:

| ¹H tip angle: | 1.5 usec. (12 degrees) |
|---|---|
| Delay between acquisitions: | 5 sec. (d1 = 4.0 sec and at =1.0 sec) |
| Spectral width: | 8 kHz |
| Buffer Size: | 16K complex |
| Number of scans: | 64 |

### Sample Preparation

0.1 ml of sample is added to 1.0 ml deuterated chloroform and then transferred to a 5 mm NMR tube.

A quality control sample may be prepared the same way and run alongside each sample set to check the precision.

### Calculating & Reporting Results

### Aliphatic Analysis

ch_db=I_{2.80-2.35} (methine next to double bond)
ch2_db=I_{2.35-1.75}/2 (methylene next to double bond)
ch3_db=I_{1.75-1.51}/3 (methyl next to double bond)
subs=ch_db+ch2_db+ch3_db
ch3=I_{1.01-0.20}/3 (methyl not next to double bond)
ch=ch3−2*ch_db−ch2_db (methine not next to double bond)
ch2=(I_{1.51-1.01}−ch)/2 (methylene not next to double bond)

### Olefinic Analysis

vinyl=I_{5.90-5.70} (vinyl olefin)
disub=I_{5.70-5.20}/2 (disubstituted olefin)
if I_{5.02-4.75}>2*I_{5.90-5.70} (trisubstituted olefin)
   trisub=I_{5.20-5.02}+I_{5.02-4.75}−2*I_{5.90-5.70}
   else
   trisub=I_{5.20-5.02}
vdene=I_{4.75-4.58}/2 (vinylidene olefin)
branch=2*disub+3*trisub+vinyl+2*vdene
tetra=(subs−branch)/4 (tetrasubstituted olefin)
if tetra<0 then tetra=0 endif
olef=disub+trisub+tetra+vinyl+vdene (sum of all olefins)
   where Iₘ₋ₙ refers to the integral between m and n ppm.

Based on the above quantities, the following may be computed:
olef_b=(trisub+vdene+2*tetra)/olef (olefin branches per chain)
alip_b=(ch_db+ch)/olef (aliphatic branches per chain)
c_no=2+(subs+ch3+ch2+ch)/olef (carbons per chain)
di=100*disub/olef (% disubstituted olefin)
tri=100*trisub/olef (% trisubstituted olefin)
tet=100*tetra/olef (% tetrasubstituted olefin)
vi=100*vinyl/olef (% vinyl olefin)
vd=100*vdene/olef (% vinylidene olefin)

The quantities olef_b, alip_b, and c_no listed above are reported.
olef_b=(olefin branches per chain)
alip_b=(aliphatic branches per chain)
c_no=(carbons per chain)

TABLE 1
NMR Analysis
Medium Branching
Sample 25731-77-2 C1518 IO

| | |
|---|---|
| Branch on Olefin | 0.41 |
| Branch on Aliphatic | 0.74 |
| Total Branches | 1.15 |
| Disub Olefin | 66.5 |
| Trisub Olefin | 23.0 |
| Tetrasub Olefin | 8.1 |
| Vinyl Olefin | 0.8 |
| Vinylidene Olefin | 1.6 |

High Branching C1518 IO
Sample 25731-78-2

| | |
|---|---|
| Branch on Olefin | 0.50 |
| Branch on Aliphatic | 1.61 |
| Total Branches | 2.11 |
| Disub Olefin | 52.4 |
| Trisub Olefin | 41.2 |
| Tetrasub Olefin | 2.9 |
| Vinyl Olefin | 0.5 |
| Vinylidene Olefin | 3.1 |

Comparative C1518 IO
Sample 25889-113

| | |
|---|---|
| Branch on Olefin | 0.06 |
| Branch on Aliphatic | 0.22 |
| Total Branches | 0.28 |
| Disub Olefin | 90.2 |
| Trisub Olefin | 5.1 |
| Tetrasub Olefin | 0.2 |
| Vinyl Olefin | 4.0 |
| Vinylidene Olefin | 0.5 |

These branched internal olefins were sulfonated and tested as described below. The comparative 0.28 mostly linear sulfonated IO was made from sample 25889-113. The 1.15 branched sulfonated IO was made from sample 25731-77-2. The 2.11 branched sulfonated IO was made from sample 25731-78-2. The 0.89 branched sulfonated IO was made by blending the 0.28 mostly linear sulfonated IO with the 2.11 branched sulfonated IO in a 2:1 ratio (0.666×0.28+0.333×2.11=0.89 branches per molecule).

Compositions and interfacial tension measurements are tabulated in Table 2. The compositions described in Table 2 were made by mixing the hydrocarbon recovery composition with brine at the desired salinity level to obtain a 0.5% active solution.

Interfacial tension values for the hydrocarbon/hydrocarbon recovery composition/water mixtures were determined using a University of Texas model spinning drop tensiometer. A four microliter (μL) drop of n-dodecane hydrocarbon was placed into a glass capillary tube that contained a hydrocarbon recovery composition/brine solution to provide a brine-to-hydrocarbon volume ratio of 400. The tube was placed into a spinning drop apparatus and then capped. The motor was turned on rapidly to rotate the tube to create a cylindrical drop within the tube (e.g. 6 to 12 ms/rev). The drop length may be greater than or equal to 4 times the width of a drop. The capillary tube and drop were heated to various temperatures (at and above 25, 50, 75 and 98° C.). The drop was video taped for later replay for measurement of the drop dimensions and calculation of the interfacial tension between the drop and the composition/brine using an Optima® System. The time range of the measurements was from about 0.1 to about 1.0 hours to achieve drop equilibrium.

The Krafft temperatures were measured by determining the minimum temperature at which no obvious crystals were observed in the 0.5% hydrocarbon recovery composition (denoted initial) and the minimum temperature at which the compositions became completely soluble in the brine phase as indicated by clarity of the solution (denoted final). The results of these measurements are shown in Table 3.

TABLE 2
INTERFACIAL TENSION VALUES FROM
SPEED AND SIZE MEASUREMENTS

| Wt % NaCl | 5% | 5% | 5% | 5% | 7% | 7% |
|---|---|---|---|---|---|---|
| Temperature | 0.28 | 0.89 | 1.15 | 2.11 | 0.28 | 0.89 |
| (° C.) | branches | branches | branches | branches | branches | branches |
| 25 | 0.29152 | 0.1981 | 0.0695 | 0.146 | 0.255 | 0.16 |
| 50 | 0.29147 | 0.2556 | 0.0395 | 0.0067 | 0.2584 | 0.0427 |
| 75 | 0.32622 | 0.0919 | 0.0503 | 0.0237 | 0.134833 | 0.03656 |
| 98 | 0.19839 | 0.147533 | 0.1115 | 0.0314 | 0.172125 | 0.1545 |
| Wt % NaCl | 7% | 7% | 9% | 9% | 9% | 9% |
| Temperature | 1.15 | 2.11 | 0.28 | 0.89 | 1.15 | 2.11 |
| (° C.) | branches | branches | branches | branches | branches | branches |
| 25 | 0.186 | 0.0374 | 0.227 | 0.263 | 0.32 | 0.221 |
| 50 | 0.011 | 0.0438 | 0.182 | 0.0295 | 0.0555 | 0.1205 |
| 75 | 0.0135 | 0.0856 | 0.081 | 0.0497 | 0.0079 | 0.01295 |
| 98 | 0.028 | 0.0565 | 0.176 | 0.0652 | 0.0164 | 0.0117 |

TABLE 3
Krafft Temperatures (° C.)
(Br = Brine)

| | Intial | Final |
|---|---|---|
| 5% Salt | | |
| 0.28 | 60 | 80 |
| 0.89 | 70 | 90 |
| 1.15 | 55 | 90 |
| 2.11 | 70 | 80 |
| 7% Salt | | |
| 0.28 | 85 | 95 |
| 0.89 | 85 | 95 |
| 1.15 | 70 | 85 |
| 2.11 | 50 | 85 |
| 9% Salt | | |
| 0.28 | >95 | >95 |
| 0.89 | >95 | >95 |
| 1.15 | 95 | 95 |
| 2.11 | 80 | 85 |

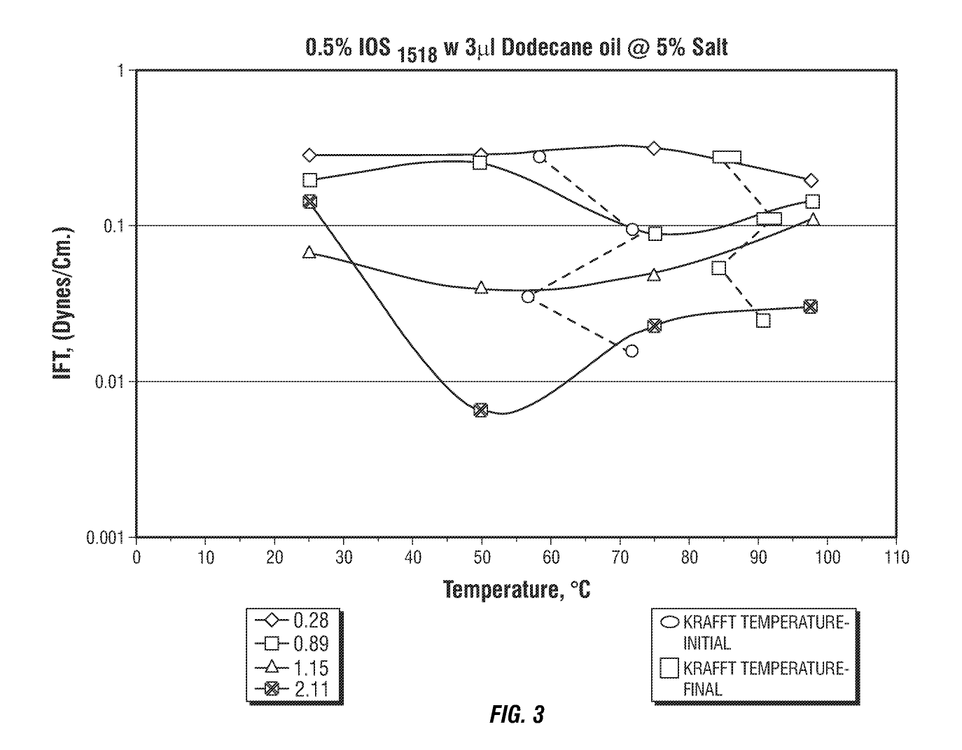

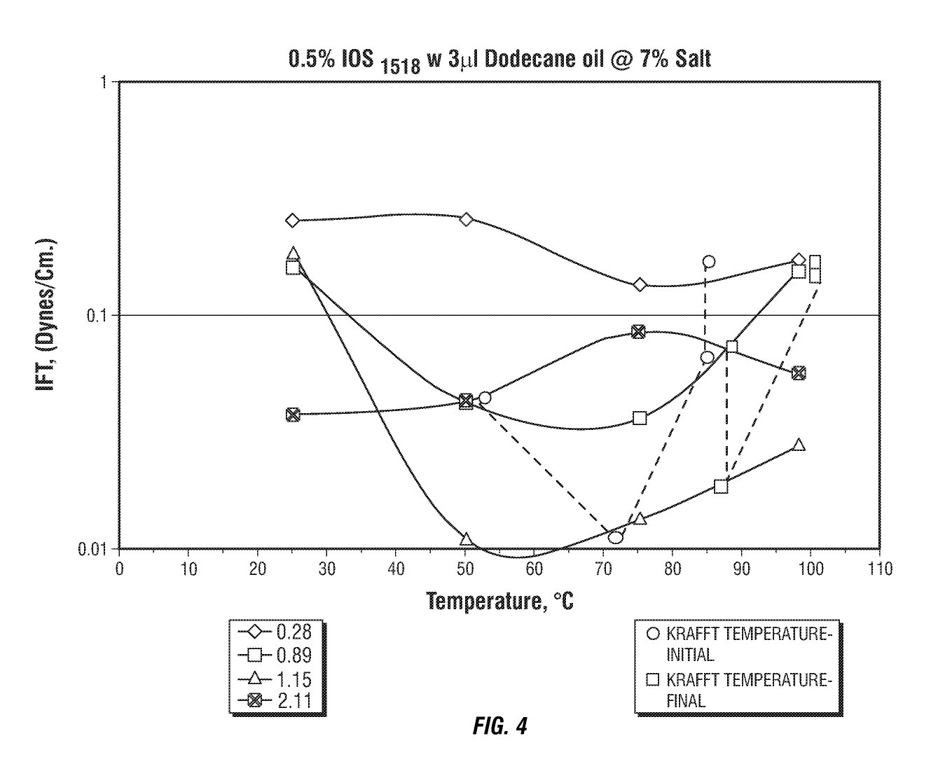

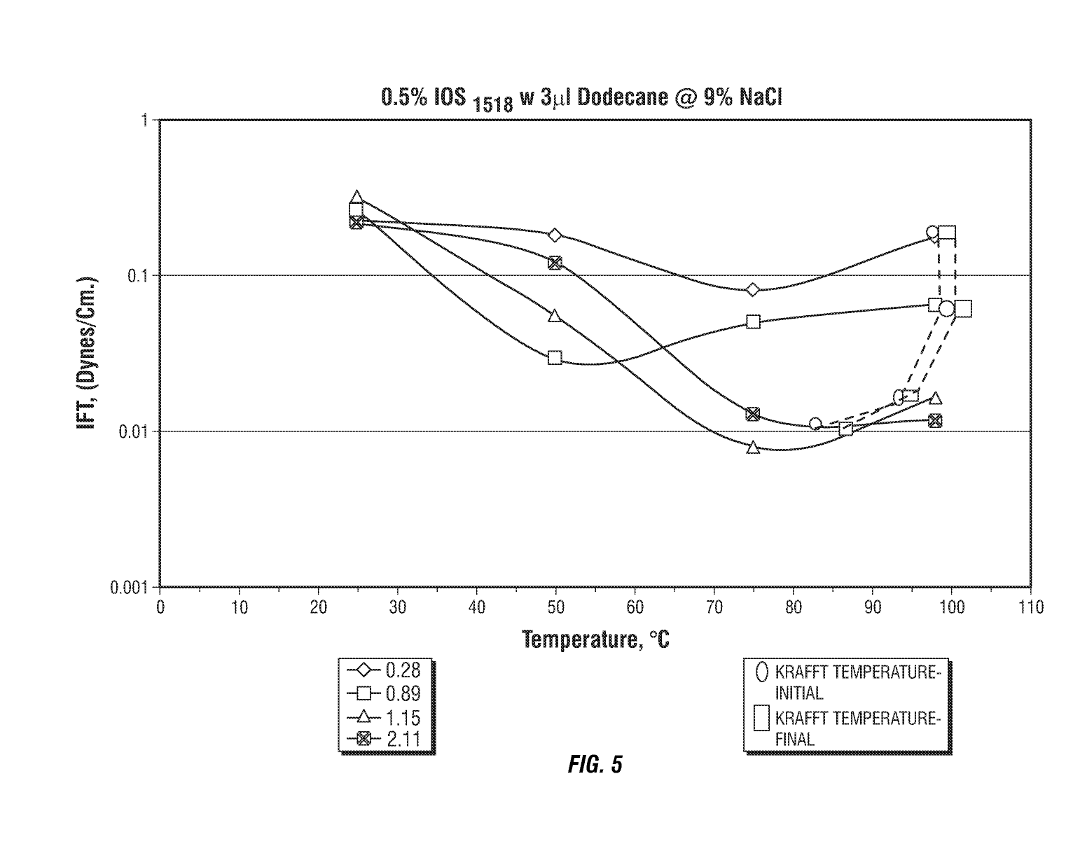

It can be seen by analyzing Tables 2 and 3 and reviewing FIGS. 3, 4 and 5 that for the systems chosen that branching at 1 or about 2 average number of branches per molecule provides lower interfacial tensions at optimum salinity and temperature conditions than those of the less branched systems although branching at about 0.9 average number of branches per molecule provided lower interfacial tension at a few isolated conditions. The comparative mostly linear internal olefin sulfonate (average number of branches per molecule of 0.28) yielded the highest interfacial tensions at most conditions. These results support the contention that branching in an internal olefin sulfate molecule may result in improved performance for enhanced oil recovery. It is also seen that branching tends to lower the Krafft temperatures slightly and thus increases the solubility of the surfactants which is also an advantage in enhanced oil recovery.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope o the invention as described in the following claims. In addition, it is to be understood that features described herein independently may, in certain embodiments, be combined.

What is claimed is:

1. A method of treating a hydrocarbon containing formation, comprising:
providing a composition to at least a portion of the hydrocarbon containing formation, wherein the composition comprises a branched internal olefin sulfonate having an average carbon number of at least 15 and an average number of branches per molecule of at least about 0.8; and
allowing the composition to interact with hydrocarbons in the hydrocarbon containing formation.

2. The method of claim 1 wherein the average number of branches per molecule is from about 0.8 to about 3.

3. The method of claim 2 wherein the average carbon number of the branched internal olefin sulfonate is from 15 to 26.

4. The method of claim 3 wherein the average carbon number is from 15 to 18.

5. The method of claim 3 wherein the average carbon number is from 17 to 20.

6. The method of claim 3 wherein the average carbon number is from 20 to 24.

7. The method of claim 2 wherein the average number of branches per molecule on the branched internal olefin sulfonate is at least about 1.

8. The method of claim 2 wherein providing the composition to at least a portion of the hydrocarbon containing formation comprises combining at least a portion of the hydrocarbon recovery composition with at least a portion of a hydrocarbon removal fluid to produce an injectable fluid; wherein an amount of the hydrocarbon recovery composition is less than about 0.5 wt. % based on the weight of the injectable fluid.

9. The method of claim 2 further comprising waterflooding at least a portion of the hydrocarbon containing formation.

10. The method of claim 2 wherein at least a portion of the hydrocarbon containing formation comprises water and wherein a salinity value for the water is less than about 13,000 ppm.

11. A composition produced from a hydrocarbon containing formation, comprising hydrocarbons, and a branched internal olefin sulfonate having an average carbon number of at least 15 and an average number of branches per molecule of at least about 0.8.

12. The composition of claim 11 wherein the average number of branches per molecule is from about 0.8 to about 3.

13. The composition of claim 12 wherein the average number of carbon atoms is from 15 to 26.

14. The composition of claim 12 wherein the average number of carbon atoms is from 15 to 18.

15. The composition of claim 12 wherein the average number of carbon atoms is from 17 to 20.

16. The composition of claim 12 wherein the average number of carbon atoms is from 20 to 24.

17. The composition of claim 12 wherein the average number of branches per molecule is at least about 1.

18. The composition of claim 12 wherein the hydrocarbon composition further comprises at least one of a polymer, methane, water, carbon monoxide, asphaltenes, hydrocarbons with a carbon number less than 10, and ammonia.

19. A branched internal olefin sulfonate having an average carbon number of at least 15 and an average number of branches per molecule of at least about 0.8.

20. The sulfonate of claim 19 wherein the average number of branches per molecule is from about 0.8 to about 3.

21. The sulfonate of claim 20 wherein the average number of branches per molecule is at least about one.

22. The sulfonate of claim 20 wherein the average number of carbon atoms is from 15 to 26.

23. The sulfonate of claim 22 wherein the average number of carbon atoms is from 15 to 18.

24. The sulfonate of claim 22 wherein the average number of carbon atoms is from 17 to 20.

25. The sulfonate of claim 22 wherein the average number of carbon atoms is from 20 to 24.
